(19) United States
(12) Patent Application Publication
(10) Pub. No.: US 2019/0066500 A1
(43) Pub. Date: Feb. 28, 2019

(54) Method for Operating a Navigation System Comprising a Vehicle and a Computing Device Outside the Vehicle, Vehicle and Computing Device

(71) Applicant: AUDI AG, Ingolstadt (DE)

(72) Inventors: Erwin ROTH, Wolnzach (DE); David LENZ, München (DE); Pascal MINNERUP, München (DE); Chao CHEN, München (DE)

(73) Assignee: AUDI AG, Ingolstadt (DE)

(21) Appl. No.: 16/077,537

(22) PCT Filed: Jan. 23, 2017
(86) PCT No.: PCT/EP2017/051302

§ 371 Date: Sep. 13, 2018

(30) Foreign Application Priority Data
Feb. 18, 2016 (DE) 10 2016 001 907.7

(51) Int. Cl. G08G 1/0968; G01C 21/34; G05D 1/00; G05D 1/02

(52) U.S. Cl. CPC G08G 1/096822; G01C 21/3461; G05D 2201/0213; G05D 1/0088; G05D 1/0214; G01C 21/3484

(57) ABSTRACT

A method for operating a navigation system including a vehicle and a computing device outside the vehicle is described. A navigation device on-board the vehicle determines, from route network data transmitted by the computing device and describing route segments of a route network, a route segment sequence. The route segment sequence includes at least one route segment and is used to reach a target position from a start position. The navigation device verifies the traversability of the route segment sequence for the vehicle, taking into account route segment information transmitted by the computing device upon a request of the navigation device, and determines a navigation route derived from a route segment sequence which has been verified to be traversable.

### TECHNICAL FIELD

The invention relates to a method for operating a navigation system comprising a vehicle and a computing device outside the vehicle.

### BACKGROUND

Navigation devices for vehicles have long been known. They typically comprise a digitally stored topographical map and a position detection device, thereby enabling navigation guidance in a public road network. Typically, the topographic map also includes coordination of so-called points of interest, which may describe car washes, workshops, gas stations, restaurants, and the like. Although this makes it possible to easily calculate a navigation route to such a place of interest, the vehicle typically only arrives at an approximate position of the place in question—such as a driveway. A navigation inside a—by way of example—gas station, to a certain gas pump or even a particular pump nozzle, is not possible with conventional navigation devices. This is because the storage capacity required for such high-resolution topographic map data is typically not available in the vehicle.

The suggestion has already been made to transmit detailed map data for an entire parking garage to a vehicle when the same enters said parking garage. Accordingly, DE 10 2010 033 215 A1 discloses a method for supporting a parking procedure in a parking garage using a parking system in a vehicle. Information about the parking garage is provided to the parking system at the entrance and/or during the occupancy of the parking garage, wherein the parking system generates and outputs control data for the vehicle by evaluating the information provided about the parking garage, and the vehicle automatically moves through the parking garage based on the control data, and/or the control data are output as navigation instructions to the driver.

However, this also requires the transmission of complete, high-resolution topographic map data via the parking garage to the vehicle, which on the one hand requires high transmission bandwidths, and on the other hand requires the provision of sufficient storage capacity in the vehicle.

### BRIEF DESCRIPTION OF THE DRAWINGS/FIGURES

FIG. 1 illustrates a schematic diagram of an embodiment of a navigation system, including a vehicle and a computing device, according to some embodiments of the disclosure.

FIG. 2 illustrates a schematic diagram of an exemplary driving situation of the vehicle shown in FIG. 1, according to some embodiments of the disclosure.

### DETAILED DESCRIPTION

The problem addressed by the invention is therefore that of providing a method for operating a navigation system with lower data transmission needs between a computing device and a vehicle.

According to the invention, to address this problem in a method of the aforementioned type, a navigation device on-board the vehicle determines, from route network data, the same transmitted by the computing device and describing route segments of a route network, a route segment sequence, which comprises at least one route segment and which is required to reach a target position from a start position, after which the navigation device verifies the traversability of the route segment sequence for the vehicle, taking into account route segment information transmitted by the computing device upon a request by the navigation device, and determines a navigation route derived from a route segment sequence which has been verified to be traversable.

The invention is based on the thought of the navigation device on-board the vehicle performing the determination of the navigation route on a database which is transmitted in a multiple step method to the vehicle by the computing device, wherein the degree of detail of the database increases at each step. For this purpose, the navigation device can first request the computing device, which in particular includes at least one back-end server, to transmit the route network data to the navigation device. The data preferably includes topographic information about a navigation environment which will soon be navigated by the vehicle, said topographic information being at least partially not stored on a data carrier of the navigation device. The route network data can describe the route network as links between multiple route segments.

The computing device can then transmit the requested route network data to the motor vehicle, and subsequently the navigation device can determine, from the route network data, the route segment sequence, the same comprising at least one route segment, which is necessary and/or required to reach a target position from a start position. In other words, the navigation device searches the route segment sequence as a route segment or a sequence of route segments which form a possible connection from the start position to the target position within the route network. Of course, several route segment sequences via which the target position can be reached from the start position can be determined. In particular, the vehicle can pass through the target position rather than coming to a stop at the same.

Subsequently, the navigation device may request the computing device to transmit route segment information for at least one route segment of the route segment sequence to the navigation device. The route segment information describes a route segment in more detail than the route network data. Subsequently, the computing device can transmit the route segment information to the navigation device, after which the navigation device verifies the traversability of the route segment sequence for the vehicle, taking into account the route segment information. The verification of the traversability particularly comprises a check for a collision with obstacles and/or boundaries described by the route segment information. If a route segment sequence is evaluated as traversable—that is, free of collisions or avoiding a collision—the navigation route is derived therefrom.

The method according to the invention therefore determines the navigation route in several steps. In a first step, a check solely for accessibility is carried out on the basis of the route network data, which requires only a small amount of storage and/or transmission capacity since it only maps links between route segments. In a second step, the much more detailed route segment information is transmitted and processed only for the relevant route segments—that is, those belonging to a route segment sequence. This accordingly avoids an extremely data-heavy transmission of route segment information for the entire route network. Also, the method according to the invention enables the operation of the navigation system with a significantly lower need for data transfer than is the case with conventional methods.

In the method according to the invention, the navigation device particularly sends the computing device a request to transmit the route network data and/or the route segment information, and transmits vehicle information describing at least one characteristic of the vehicle to the computing device. Next, the computing device transmits route network data and/or route segment information, filtered according to the vehicle information, to the navigation device. In order to further reduce the necessary data transmission, it is therefore proposed that the computing device perform a pre-filtering of the route network data and/or route segment information which will be transmitted. By way of example, the vehicle information may describe a vehicle class, such as passenger car, semi-truck, motorhome, vehicle with trailer, and/or the outside dimensions of the vehicle. The computing device can then filter the route network data and/or route segment information which will be transmitted, to filter out the route segments which must be regarded as not traversable based on the vehicle information. However, a final and/or exact verification of traversability is preferably carried out by the navigation device on the basis of the transmitted route segment information.

The method according to the invention expediently uses route network data which describe the route network as a graph, wherein edges of the graph represent route segments, and/or a node of the graph represents the start position, and/or a node of the graph represents the target position. The term ‘graph’ in this case is to be understood as a data structure which represents a set of objects (nodes) together with the connections (edges) existing between these objects, and can be described, for example, by an adjacency matrix or an adjacency list. In particular, the route segment sequence is represented by a list of indices describing edges and/or nodes. The representation of the route network as a graph thereby enables a particularly compact and data-saving description of the route network. In addition, a variety of high-performance search algorithms are generally known for this description—for example, the A* algorithm. When the navigation device requests the route segment information, it can particularly address the route segments by using an index describing an edge and/or at least one node.

Moreover, in the method according to the invention, it is preferred that route segment information is used which describes a geometric shape of the route segment and/or restrictions for the movement of a vehicle along the route segment, and/or a reference trajectory for a vehicle along the route segment, and/or includes information about localization features within the navigation environment. The geometric shape of the route segment can particularly relate to its two- or three-dimensional measurements, wherein obstacles can also be depicted in the region of the route segment. In particular, a polygonal line can be used to describe the measurements. The restrictions may particularly describe non-traversable areas or areas which are not permitted to be traversed, and/or traffic rules. A trajectory to be used preferentially by the vehicle in its movement along the route segment may be prespecified as a reference trajectory along the route segment sequence. In particular, the reference trajectory can be selected as part of the navigation route. Localization features may be, for example, artificial or natural markers detectable by a sensor of the vehicle. In particular, the route segment information can be used as metadata for the navigation route.

In the method according to the invention, it is also preferred that the navigation device additionally takes into account, when verifying the traversability of the route segment sequences and/or when determining the navigation route, information about the vehicle—particularly describing the dimensions of the vehicle and/or movement options of the vehicle. This enables the determination of a collision-free and/or collision-avoiding navigation route. The information about the vehicle can also be identical to the vehicle information.

Moreover, in the case of the method according to the invention, it is particularly expedient for the navigation device to make a request multiple times to the computing device to transmit the route segment information. The navigation device prompts the computing device to transmit route segment information for each route segment which will be verified next. Alternatively or additionally, the computing device may be prompted multiple times to send different route segment information for each route segment. This allows requests for sequentially more detailed route segment information as needed. An abort criterion can be provided, for example, if a route segment of a route segment sequence is evaluated as non-traversable or if a verification computing limit of a route segment is reached.

In the method according to the invention, it is particularly preferred for route network data describing a route network of a service station comprising at least one service facility to be used. A service station may be, for example, a car wash with at least one washing station and/or at least one wash line as a service facility, a workshop with at least one workshop station as a service facility, a bus stop and/or taxi stand with at least one inductive charging device for electric vehicles as a service facility, a toll station with at least one pay station as a service facility, a ferry terminal, a restaurant with at least one drive-through window as a service facility, a vehicle or goods testing station with at least one scale and/or at least one fluoroscopic device and/or at least one test station as a service facility, or a place of interest. As mentioned above, the vehicle does not have to come to a stop at the service facility—particularly in the case of a car wash, an inductive charging device or a fluoroscopic device. In addition, when the computing device requests that the route network data be transmitted, the navigation device can transmit passenger information to the computing device which describes at least one service facility which the passenger of the vehicle desires to drive to, and/or a service which is desired by a passenger and which is provided by a service facility of the service station, wherein the computing device selects the route network data which will be transmitted according to the passenger information. Preferably, an occupancy information describing the occupancy of individual service facilities is additionally transmitted to the navigation device by the computing device, wherein the occupancy information can be taken into account in the determination and/or the verification of the route segment sequence.

The position of a service facility can be used as the target position, or the navigation device can select the route segment sequence in such a manner that the vehicle is guided along a service facility and/or through a service facility. The latter is particularly useful for the car wash as a service station, or when driving over the inductive charging device, or when driving through the fluoroscopic device. A route segment may lead along or through a service station.

Alternatively or in addition, for determining at least a part of the navigation route which is relevant to reaching the service facility, service facility information which describes the service facility can be transmitted by the computing device following a request by the navigation device. The exact determination of the navigation route to reach the service facilities may require specialized algorithms under certain circumstances, due to special geometric properties or properties of vehicle kinematics. For this reason, there may be a further step which adds more detail to the database. For example, a vehicle—specific trajectory to reach the service facility can be determined, taking into account special geometrical conditions in the area of the service facilities—in particular, the location of loading or unloading ramps, a lift, or test or calibration stands—the vehicle type, particular preferences of a passenger, or special loading or unloading criteria. Alternatively or additionally, it can be contemplated that a single-maneuver or multi-maneuver path is determined to reach a position on a route segment to the service facility, without a collision and/or avoiding a collision.

In the method according to the invention, the navigation device can also determine a plurality of possible navigation routes and, in particular, evaluate them according to a cost function. In this case, the cost function assigns a cost value to a navigation route for a movement of the vehicle, and can take into account and/or weigh its distance, a movement duration of the vehicle, fuel consumption, and maneuvering to reach the end position. The possible navigation routes can therefore be ordered or sorted according to the rating.

Moreover, in the method according to the invention, it is preferred if navigation route data describing the navigation route, in particular the highest-rated navigation route or a navigation route selected by a passenger of the vehicle, is provided to a track—following control device and/or a trajectory planning device of the vehicle. The navigation device can thus generate navigation route data from the navigation route or, if multiple, possible navigation routes have been determined, from the highest-rated navigation route, which it then preferably supplements at least with parts of the route segment information as metadata.

Finally, in the method according to the invention, a motor vehicle or aircraft or a driverless means of transport can be used as the vehicle. The vehicle can be operated autonomously or partially-autonomously. In particular, in the case of a motor vehicle, the navigation route can be used for an assistance system assisting the driver, which generates navigation instructions for the steering of the motor vehicle.

In addition, the invention relates to a vehicle having a navigation device, wherein the vehicle is designed to carry out the method according to the invention.

Moreover, the invention relates to a computing device which is designed to carry out the method according to the invention.

All versions of the method according to the invention can be analogously applied to the vehicle according to the invention and to the computing device according to the invention, such that the aforementioned advantages can be achieved with the same.

Further advantages and details of the invention will become apparent from the embodiments described below and with reference to the drawings. These are schematic representations, wherein:

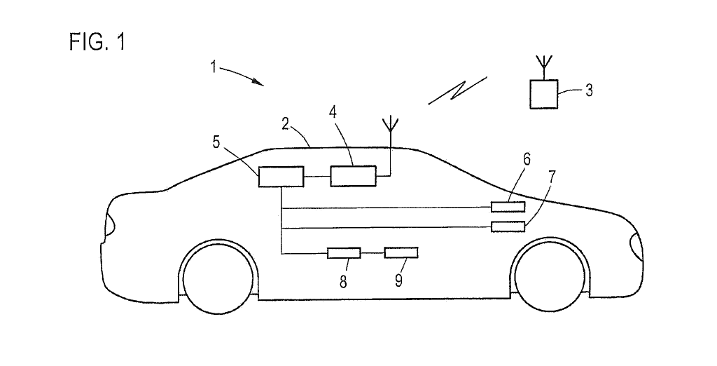

FIG. 1 shows a schematic diagram of an embodiment of a navigation system, comprising a vehicle according to the invention and a computing device according to the invention; and

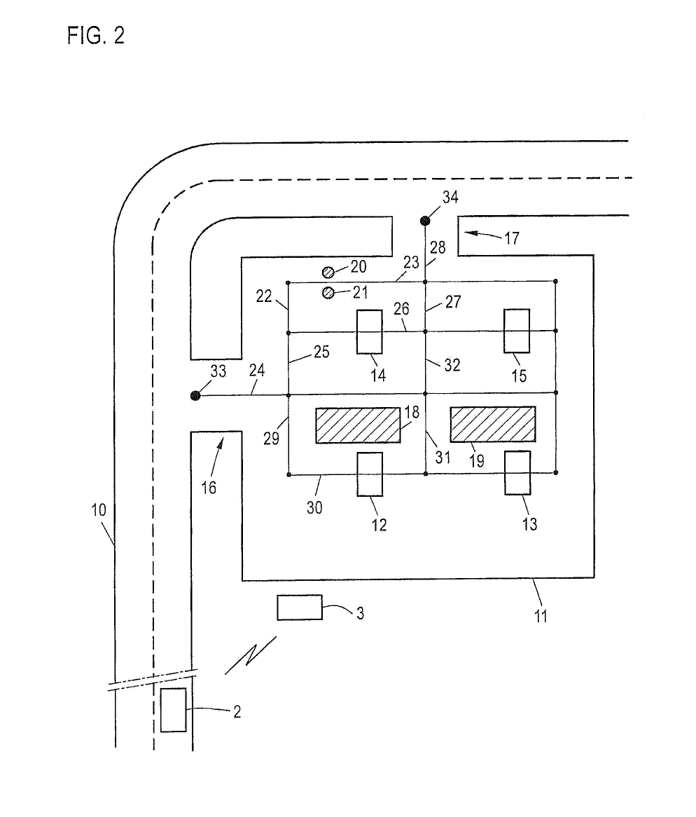

FIG. 2 shows a schematic diagram of an exemplary driving situation of the vehicle shown in FIG. 1.

FIG. 1 is a schematic diagram of an embodiment of a navigation system 1, comprising a vehicle 2 and a computing device 3.

In the present case, the vehicle 2 is designed as an autonomously-operated motor vehicle, wherein, in further embodiments, the vehicle 2 is designed for partially-autonomous, or merely assisted, operation, or is designed for a driverless transport system or an aircraft. The vehicle 2 has a communication device 4 for wireless data communication with the computing device 3, and a navigation device 5 connected to the communication device 4. An optical and acoustic output unit 6 and an input unit 7 for receiving manual input control and/or voice input control of a passenger of the vehicle 2 are connected to said navigation device. Additionally included are a trajectory planning device 8 and a downstream track-following control device 9, which use navigation route data of the navigation device 5 for automated lateral and longitudinal guidance of the vehicle 2. In a vehicle 2 which is only partially-autonomously operated, the trajectory planning device 8 is omitted. In a vehicle 2 which assists the driver, navigation instructions which can be output by means of the output unit 6 are generated from the navigation route data.

The vehicle 2 is wirelessly connected via the communication device 4 to the computing device 3, which comprises one or more back-end servers.

FIG. 2 is a schematic diagram of an example of a driving situation of the vehicle 2 approaching, on a public road 10, to a service station 11 with four service facilities 12-15. The service station has an entrance 16 and an exit 17, as well as a plurality of areas 18-21 which must not be traversed. Consequently, a route network within the service station 11 is made of individual route segments, of which only the route segments 22-32 are indicated by reference numbers. The route network is described by route network data which is stored in the computing device 3. The vehicle 2 and the computing device 3 are designed to carry out a method for operating the navigation system 1. The sequence of the method is explained in more detail below based on the driving situation.

Based on an operator input by the passenger of the vehicle 2, or an automated route- or fleet planning, which prompts for an approach to the service station 11, the navigation device 5 transmits via the communication device 4 a request, to the computing device 3, that the computing device 3 transmit route network data. This request includes vehicle information describing a characteristic of the vehicle 2—regarding its vehicle class and outer dimensions.

Upon this request, the computing device 3 transmits the route network data, which describe the route network as a graph, to the navigation device 5, wherein edges of the graph represent route segments and nodes of the graph represent connections between these route segments. One of the nodes of the graph corresponds to a start position 33 at the entrance 16, and one of the nodes corresponds to a target position 34 at the entrance 17 of the service station 11. In this case, the computing device 3 filters, according to the vehicle information, the route network data which will be transmitted, wherein the route segments 21, 22 are not transmitted because the computing device 3 has already determined in advance, based on the outer dimensions and the vehicle type of the vehicle 2, that the route segment 22 is not traversable due to the areas 20, 21 which must not be traversed.

The navigation device 5 verifies the route segment data for potential route segment sequences via which the service facilities 12-14 can generally be reached. This is done by the navigation device 5 carrying out a graph search—for example, by means of the A* algorithm—on the transmitted route network data, in which it determines multiple route segment sequences which are required to navigate the vehicle 2 from the start position 33 through one of the service facilities 12-15 to the target position 34. In the present case, a determined route segment sequence comprises the route segments 24-28, and a further route segment sequence comprises the route segments 24, 29-32, 27, 28. Further determined route segment sequences are not listed here individually for reasons of clarity. The route segment sequences determined in this way are the basis for the determination of multiple possible navigation routes from the start position 33 to the target position 34. As a result, sorted lists of route segments 24-32 are available for each route segment sequence.

Next, the navigation device 5 sequentially requests the computing device 3 to transmit the route segment information which describes the route segments 24-32 of the determined route segment sequence. This route segment information describes the geometric shape of the route segments 24-32, restrictions on the movement of the vehicle 2—such as special traffic rules—a reference trajectory for the vehicle 2 along a route segment 22-28, and includes information about location features within the service station 11 which can be detected by a sensor system of the vehicle 2. The individual route segments are thus described by the route segment information in much greater detail than by the route network data. The computing device 3 then filters the route segment information which will be transmitted like the route segment data, taking into account the vehicle information in such a way that only route information which is relevant for the vehicle type and the external dimensions of the vehicle 2 is transmitted. The computing device 3 further transmits occupancy information which describes the occupancy of the service facilities 12-15 and from which time periods for an occupancy of the service facilities 12-15 are obtained. Likewise, information about obstacles for the vehicle 2 which are only temporary in the service station 11 is transmitted to the navigation device 5.

The navigation device 5 then verifies the route segment sequences for their traversability for the vehicle 2, taking into account the route segment information, the occupancy information, and the further information about temporary obstacles, in such a manner that collisions of the vehicle 2 within the service station 11 are avoided. For this purpose, the navigation device 5 evaluates the route segment information describing the geometric shape of a respective route segment 24-32, which describes an available movement space as a three-dimensional polygonal line, wherein the navigation device 5 additionally takes into account its own information about the dimensions of the vehicle 2 and its movement options.

In verifying the traversability 5, the navigation device sequentially requests the computing device 3 to transmit route segment information for each route segment 24-32 which will be verified next for traversability. If the verification of the traversability requires route segment information which is more detailed than that which has already been transmitted, the navigation device 5 sends a request to the computing device 3 again, and optionally multiple times, for transmission of different route segment information for each respective route segment 24-32. In this case, a termination criterion is provided, which evaluates the time required for verifying the traversability, and optionally ends the request for further route segment information. This results in route segment sequences verified as traversable—that is, possible navigation routes.

Subsequently, the navigation device 5 sends a request to the computing device 3 to determine service facility information. This information describes detailed geometric conditions and obstacles of each respective service facility 12-15. The service facility information is thus even more detailed than the route segment information. If the service facilities 12-15 are, for example, workshop spaces or a loading facility, the service facility information precisely describes the position of a lifting platform or test and calibration stands and/or a loading or unloading ramp. The navigation device 5 then determines an exact, optionally multi-maneuver trajectory for a part of each possible navigation route which is relevant to reaching the service facility 12-15, taking into account the service facility information.

The navigation device 5 rates each of the respective, potential navigation routes according to a cost function which describes the effort of moving the vehicle 2 along the route segment sequences, and sorts the route segment sequences based on their rating. The navigation device 5 supplements the highest-rated navigation route with the route segment information, which describes the localization features, the restrictions and the reference trajectory, to form the navigation route data which it transmits to the trajectory planning device 8. In an alternative embodiment, the rated and sorted possible navigation route data is displayed to a passenger of the vehicle 2 on the output unit 6. A navigation route selected by the passenger via the operating unit 7 is then supplemented with the route segment information. The navigation route data thus formed are then transmitted to the trajectory planning device 8.

As soon as the vehicle 2 has reached the start position 33 via the road 10, the vehicle 2 can be guided through the service station 11 along the selected navigation routes by means of the track-following device 9.

According to further embodiments, the service station 11 is a car wash having at least one washing station or at least one wash line as the service facility 12-15, or a workshop with at least one workshop space as the service facility 12-15, or a bus stop and/or taxi stand having at least one inductive charging device for electric vehicles as the service facility 12-15, or a toll station with at least one pay station as the service facility 12-15, or a ferry station, or a restaurant with at least one drive-through window as a service facility 12-15, or a vehicle or goods testing station with at least one scale, at least one fluoroscopic device, or at least one test station as the service facility 12-15, or a place of interest.

1.-14. (canceled)

15. A method for operating a navigation system, the method comprising:
determining, by a navigation device on-board a vehicle, from route network data received from a computing device outside the vehicle and describing route segments of a route network, a route segment sequence,
wherein the route segment sequence comprises at least one route segment and is used to reach a target position from a start position;
verifying, by the navigation device, a traversability of the route segment sequence for the vehicle by considering route segment information received from the computing device upon a request by the navigation device; and
determining a navigation route derived from the route segment sequence, which has been verified to be traversable.

16. The method of claim 15, further comprising:
sending, by the navigation device, the request to the computing device to transmit the route network data and/or the route segment information;
transmitting, by the navigation device, vehicle information to the computing device, wherein the vehicle information describes at least one characteristic of the vehicle; and
receiving, by the navigation device and from the computing device, the route network data and/or the route segment information that are filtered according to the vehicle information.

17. The method of claim 15, wherein the route network data describes the route network as a graph, edges of the graph representing the route segments, a first node of the graph representing the start position, and/or a second node of the graph representing the target position.

18. The method of claim 15, wherein the route segment information describes a geometric shape of the route segment, restrictions for a movement of the vehicle along the route segment, a reference trajectory for the vehicle along the route segment, and/or includes information about localization features for the vehicle.

19. The method of claim 15, further comprising:
considering, by the navigation device, information about the vehicle when verifying the traversability of the route segment sequences and/or when determining the navigation route, information about the vehicle.

20. The method of claim 19, wherein the information about the vehicle comprises information describing dimensions of the vehicle and/or movement options of the vehicle.

21. The method of claim 15, further comprising:
sending, by the navigation device, a request multiple times to the computing device to transmit the route segment information.

22. The method of claim 15, wherein the route network data describes a route network of a service station comprising at least one service facility.

23. The method of claim 22, wherein the target position comprises a position of the service facility.

24. The method of claim 22, further comprising:
selecting, by the navigation device, the route segment sequence such that the vehicle is guided along the service facility and/or through the service facility.

25. The method of claim 22, further comprising:
transmitting, by the navigation device, a second request to the computing device; and
receiving, by the navigation device and from the computing device, additional service facility information describing the service facility to be used for determining at least a part of the navigation route for reaching the service facility.

26. The method of claim 15, further comprising:
determining, by the navigation device, a plurality of possible navigation routes; and
evaluating the plurality of possible navigation routes according to a cost function.

27. The method of claim 15, further comprising:
providing to a track-following control device and/or a trajectory planning device of the vehicle navigation route data describing the navigation route, wherein the navigation route comprises a highest-rated navigation route or a navigation route selected by a passenger of the vehicle.

28. The method of claim 15, wherein the vehicle comprises a motor vehicle, a driverless means of transport, or an aircraft.

29. A vehicle, comprising:
a navigation device configured to:
determine, from route network data received from a computing device outside of the vehicle and describing route segments of a route network, a route segment sequence, wherein the route segment sequence comprises at least one route segment and is used to reach a target position from a start position;
verify a traversability of the route segment sequence for the vehicle, considering route segment information received from the computing device upon a request by the navigation device; and
determine a navigation route derived from the route segment sequence, which has been verified to be traversable.

30. The vehicle of claim 29, wherein the navigation device is further configured to:
transmit the request to the computing device to transmit the route network data and/or the route segment information;
transmit vehicle information to the computing device, wherein the vehicle information describes at least one characteristic of the vehicle; and
receive, from the computing device, the route network data and/or the route segment information that are filtered according to the vehicle information.

31. The vehicle of claim 29, wherein the route network data describes a route network of a service station comprising at least one service facility and the navigation device is further configured to:
transmit a second request to the computing device; and
receive, from the computing device, additional service facility information describing the service facility to be used for determining at least a part of the navigation route for reaching the service facility.

32. A computing device outside of a vehicle, wherein the computing device is configured to:
transmit, to a navigation device of a vehicle, route network data that describes route segments of a route network; and
transmit, to the navigation device and upon receiving a request from the navigation device, route segment information,
wherein the navigation device is configured to:
determine, from the route network data, a route segment sequence, the route segment sequence comprising at least one route segment and is used to reach a target position from a start position;
verify a traversability of the route segment sequence for the vehicle, considering the route segment information; and
determine a navigation route derived from the route segment sequence, which has been verified to be traversable.

33. The computing device of claim 32, further configured to:
receive the request from the navigation device to transmit the route network data and/or the route segment information;
receive vehicle information from the navigation device, wherein the vehicle information describes at least one characteristic of the vehicle; and
transmit, to the navigation device, the route network data and/or the route segment information that are filtered according to the vehicle information.

34. The computing device of claim 32, wherein the route network data describes a route network of a service station comprising at least one service facility and the computing device is further configured to:
receive a second request from the navigation device; and
transmit, to the navigation device, additional service facility information describing the service facility to be used for determining at least a part of the navigation route for reaching the service facility.
